(19) United States
(12) Patent Application Publication
(10) Pub. No.: US 2016/0127585 A1
(43) Pub. Date: May 5, 2016

(54) FACSIMILE FOR MOBILE PLATFORMS

(71) Applicant: Xerox Corporation, Norwalk, CT (US)

(72) Inventors: MICHAEL H. WANG, MACEDON, NY (US); FRANCIS KAPO TSE, ROCHESTER, NY (US); SURYA PRAKASH KOTHA, CHENNAI (IN); AMRITA SHAILINI DIOL, ROCHESTER, NY (US); CHRISTOPHER MARK VILLONE, MACEDON, NY (US); PREMKUMAR RAJENDRAN, WEBSTER, NY (US); DEEPAK RAVISHANKAR RAMKUMAR, BUFFALO, NY (US)

(21) Appl. No.: 14/528,233

(22) Filed: Oct. 30, 2014

(51) Int. Cl. H04N 1/00; H04N 1/32

(52) U.S. Cl. CPC H04N 1/00477; H04N 1/00474; H04N 1/00493; H04N 1/32128; H04N 1/00307; H04N 2201/0017; H04N 2201/0094; H04N 2201/0093; H04N 2201/3209; H04N 2201/3218

(57) ABSTRACT

A portable computing device is connected to another device that has an optical scanner and a facsimile modem. An application on the portable computing device causes the optical scanner to scan an item and causes the separate device to transmit the electronic image of the scanned item to the portable computing device. The application receives facsimile information into a graphic user interface of the portable computing device. Then, the application creates a facsimile file by combining the electronic image and the facsimile information. The facsimile file is transmitted to the separate device, and the application causes the separate device to send the converted electronic image as a facsimile using the facsimile information contained within the facsimile file. The portable computing device receives the result of the attempt to send the facsimile from the separate device, and this result is displayed on the graphic user interface of the portable computing device.

### BACKGROUND

Systems and methods herein generally relate to facsimile devices, and more particularly to operating a facsimile device using separate mobile devices.

Historically, facsimile capability is one of the more difficult features to support across multifunction products (MFP). Facsimile ability can require a physical facsimile modem board embedded within MFP devices, and should be implemented via proprietary and embedded set of application programming interfaces (API's) for communication and control. This prevents the ease of use and integration for most of the out of box solutions, including facsimile integration with mobile workflows. Further, there are limitations with the platform web services API's that were designed to support partners, vendors and other types of out-of-box integration. For example, API's may only support copy, scan, and print functions, without mobile integration.

### SUMMARY

Exemplary methods herein operatively (meaning directly or indirectly, such as through a wired connection or a wireless connection) connect a portable computing device (e.g., a smart phone) to another device (e.g., a multifunction device (MFD)) that is separate from the portable computing device and that has, among other components, an optical scanner and a facsimile modem. Once the two are operatively connected, these methods operate an application (such as an API, a platform API workflow program, a specialty application, etc., all of which are referred to herein simply as “application” for shorthand) on the portable computing device to cause the optical scanner to scan an item to create an electronic image of the item.

Further, with these methods, the application on the portable computing device causes the separate device to transmit the electronic image to the portable computing device. Also, the application receives facsimile information, such as the recipient's facsimile telephone number, name, company, etc., into a graphic user interface of the portable computing device.

Then, with these methods, the application operating on the portable computing device creates a facsimile file by converting and combining the electronic image and the facsimile information (e.g., by including the facsimile information in a header of the facsimile file). These methods can also create a facsimile coversheet by placing portions of the facsimile information into a facsimile coversheet template, using the portable computing device, and then add the facsimile coversheet to the facsimile file. The facsimile file has a file format usable by the separate device (e.g., any page description language (PDL) format, including, but not limited to postscript (PS), portable document format (PDF), printer control language (PCL), graphics interchange format (GIF), tag image file format (TIFF), portable bitmap (PBM), portable network graphics (PNG), etc.). Then, these methods transmit the facsimile file from the portable computing device to the separate device, using the application.

In addition, with these methods, the application causes the separate device to send the converted electronic image (potentially with the coversheet) as a facsimile using the facsimile information contained within the facsimile file. After the facsimile transmission is successful (or fails), the portable computing device receives the result of the attempt to send the facsimile from the separate device, and this result is displayed on the graphic user interface of the portable computing device.

Devices herein include a special-purpose portable computing device that has, among other components, a processor operating an application, a graphic user interface operatively connected to the processor, an input/output connection (e.g., a wired or wireless connection), etc. For example, the portable computing device can be a special-use device such as a smart phone, tablet, or other special-purpose portable computerized element that is easily carried by a user. The input/output connection is operatively connected to a separate device, such as a fax machine, multifunction device (MFD). The separate device has at least an optical scanner and a facsimile modem.

The application running on the portable computing device is in communications with the separate device, and has the ability to control certain functions of the separate device. Therefore, the application directs the optical scanner of the separate device to scan an item to create an electronic image of the item. The application also causes the separate device to transmit the electronic image to the portable computing device.

The application provides many displays on the graphic user interface of the portable computing device, and one of these displays provides input fields for receiving facsimile information. The application uses the processor within the portable computing device to create a facsimile file by combining the electronic image received from the separate device and the facsimile information input by the user to the graphic user interface. The facsimile file has a file format usable by the separate device, so that the separate device can easily process the file.

The input/output connection transmits the facsimile file to the separate device, and the application causes the separate device to send the converted electronic image as a facsimile using the facsimile information contained within the facsimile file. After the facsimile transmission attempt, the input/output connection receives, from the separate device, a result of the separate device attempting to send the facsimile. The graphic user interface displays the result of the separate device attempting to send the facsimile.

These and other features are described in, or are apparent from, the following detailed description.

### BRIEF DESCRIPTION OF THE DRAWINGS

Various exemplary systems and methods are described in detail below, with reference to the attached drawing figures, in which:

FIG. 1 is a schematic diagram illustrating devices herein;

FIG. 2 is a schematic diagram illustrating a screenshot herein;

FIG. 3 is a schematic diagram illustrating a coversheet herein;

FIG. 4 is a schematic diagram illustrating a screenshot herein;

FIG. 5 is a flow diagram of various methods herein;

FIG. 6 is a schematic diagram illustrating devices herein; and

FIG. 7 is a schematic diagram illustrating devices herein.

### DETAILED DESCRIPTION

As mentioned above, issues with facsimile equipment and applications prevent the ease of use and integration for most of the out of box solutions including facsimile integration with mobile workflows. Therefore, the systems and methods herein combine the use of platform API's and printer ready file formats (e.g., printer description language (PDL)).

One implementation uses a platform scan API to acquire an image (or document) to be facsimiled, then the systems and methods herein convert the file format to a specific printer ready file format (i.e., PDF) and send it back to the MFP as a facsimile type print job. This implementation includes a user interface on the mobile device that allows the user to enter the job information (i.e., facsimile destination number). The user places the original document on the platen glass or automatic document feeder (ADF), and the platform scan API acquires the image. The systems and methods herein then convert the binary file format of the scanned image to a specific printer ready file format (i.e. PDF) using, for example a message transmission optimization mechanism (MTOM) library and send the converted file back to the MFP as a facsimile type print job. As part of the overall facsimile job, the print job content can be wrapped with PDL that identifies the file as a facsimile job type for the printer device (with some metadata (i.e., person name, facsimile destination number, etc.)).

Thus, the systems, devices, and methods herein utilize a library (such as a specific MTOM library implementation on mobile platforms, utilize a combination of scan and print to provide a seamless facsimile workflow to the end user, provide a print job submission over well-known print paths, present an implementation that is easily ported/transferred across different mobile platform environments, and provide a universal method to address the need for facsimile workflow usages.

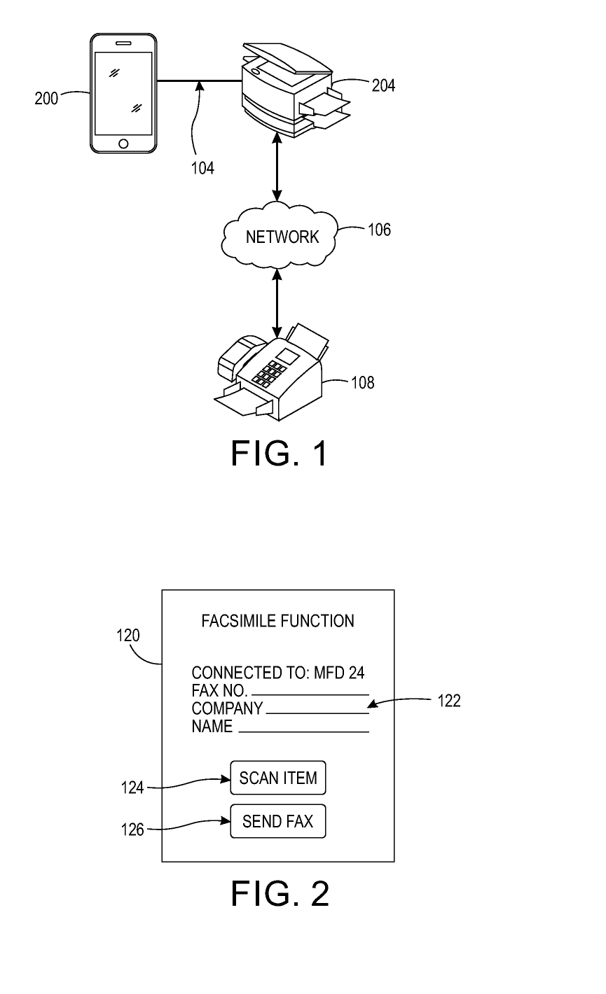

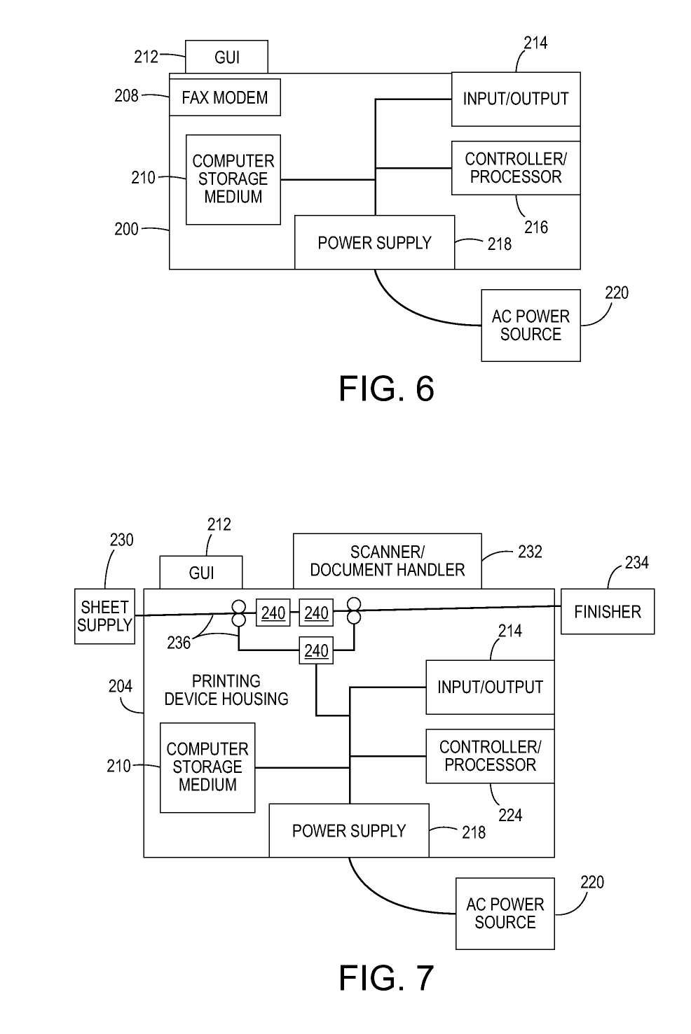

As shown in exemplary FIG. 1, devices herein include a portable computing device 200 that has, among other components (some of which are shown in FIG. 6, discussed below) a processor 216 operating an application, a graphic user interface 212 operatively connected to the processor 216, an input/output connection 214 (e.g., a wired (direct cables, wired networks with routers, etc) or wireless connection, such as wireless fidelity (WiFi), near field communications (NFC), wide area networks (WAN (cellular phone service, Internet, etc.)), local area networks (LAN), etc). For example, the portable computing device 200 can be a smart phone, tablet, portable digital assistant (PDA), or other portable computerized component that is easily portable, and can be normally carried by a user and has wired and wireless connections.

The input/output connection 214 is operatively connected to a physically separate device 204, such as a fax machine, multifunction device (MFD), etc., by way of a wired or wireless connection (shown generically as item 104, which could be any of the aforementioned connection types, or others). Some components of the separate device 204 are shown in FIG. 7 (discussed below). For example, FIG. 7 illustrates that the separate device 204 has at least an optical scanner 232 and a facsimile modem 208 or facsimile capabilities, such as fax over internet protocol (FoIP).

The application running on the portable computing device 200 is in communications with the separate device 204, and has the ability to control certain functions of the separate device 204, either directly, through a network platform, etc. Further, such control of the separate device 204 only uses input to the portable computing device 200, and the user does not need to take any physical action with the separate device 204 (except supplying and removing the item that is being scanned). The user provides all instructions for the facsimile operation through the graphic user interface of the physically separate portable computing device 200, and does not provide any instructions or input to the separate device 204. Therefore, the application running on the portable computing device 200 directs the optical scanner 232 of the separate device 204 to scan an item to create an electronic image of the item. The application also causes/controls the separate device 204 to transmit the electronic image to the portable computing device 200.

The application provides many displays on the graphic user interface 212 of the portable computing device 200. One of these displays, shown as item 120 in FIG. 2, provides input fields 122 for receiving facsimile information, such as the recipient's facsimile number, company, name, etc. Such input fields can be completed using any user interface component of the portable computing device 200, such as keyboard/keypad, touch screen, voice recognition, etc. Note that the data can be input to fields 122 at any time (from when the application is first made active, until just before the facsimile is sent).

Items 124 and 126 in FIG. 2 are exemplary radio-style buttons (but also represent any other type of user-selectable items) that the user selects (e.g., pushes, taps, points to, clicks on, etc.) to cause the scanner 232 of the separate device 204 to scan (button 124) or to cause the facsimile modem 208 of the separate device 204 to send a facsimile transmission (button 126).

The application uses the processor 216 within the portable computing device 200 to create a facsimile file by converting and combining the electronic image received from the separate device 204 and the facsimile information input by the user to the graphic user interface 212 (e.g., by adding the facsimile information as a header to the electronic image). More specifically, the bitmap image from the scanner 232 is converted (potentially using a library, such as a specific MTOM library) into a printer-ready format. Such printer-ready formats can include: any page description language (PDL) format, including, but not limited to postscript (PS), portable document format (PDF), printer control language (PCL), graphics interchange format (GIF), tag image file format (TIFF), portable bitmap (PBM), portable network graphics (PNG), etc. The facsimile file is created to have a file format usable by the separate device 204, so that the separate device 204 can easily process the file.

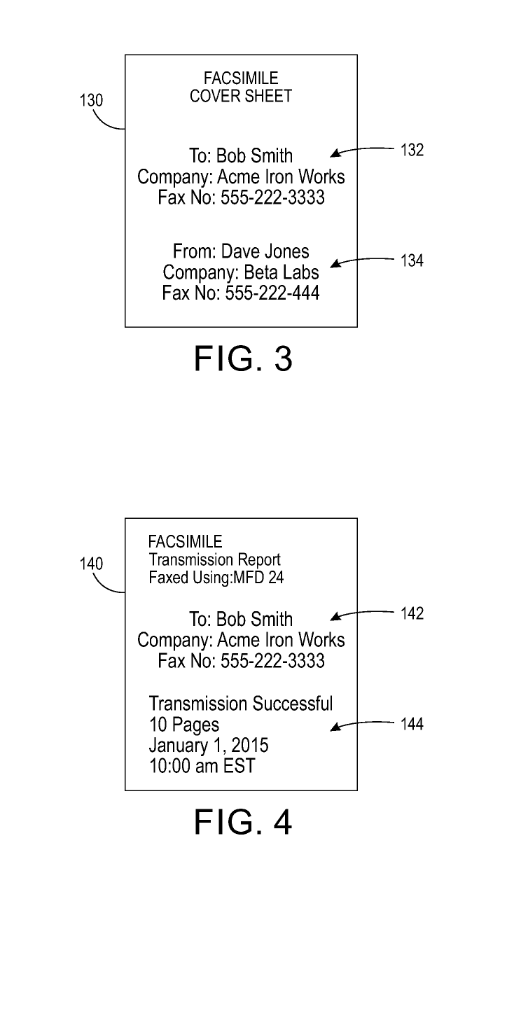

The application can also create a facsimile coversheet by placing portions of the facsimile information into a facsimile coversheet template, using the portable computing device, and then add the facsimile coversheet to the facsimile file. One exemplary facsimile coversheet 130 is shown in FIG. 3, and it includes information about the recipient of the facsimile 132 (portions of the facsimile information) and information about the sender of the facsimile 134 (which can be part of the facsimile coversheet template).

The input/output connection 214 transmits the facsimile file to the separate device 204 (e.g., upon user selection of “send fax” button 126) and the application causes the separate device 204 to send the converted electronic image as a facsimile using the facsimile information contained within the facsimile file to a facsimile recipient 108 through any form of telephone network 106 (e.g., cellular, plain old telephone service (POTS), public switched telephone networks (PSTN), voice over internet protocol (VoIP) etc.).

After the facsimile transmission attempt, the input/output connection 214 receives, from the separate device 204, a result of the separate device 204 attempting to send the facsimile. The graphic user interface 212 displays the result of the separate device 204 attempting to send the facsimile as shown, for example, in FIG. 4. More specifically, the facsimile transmission report 140 shown in FIG. 4 includes the recipient information 142 and information about the facsimile transmission 144 (whether successful, number of pages, date and time, etc.).

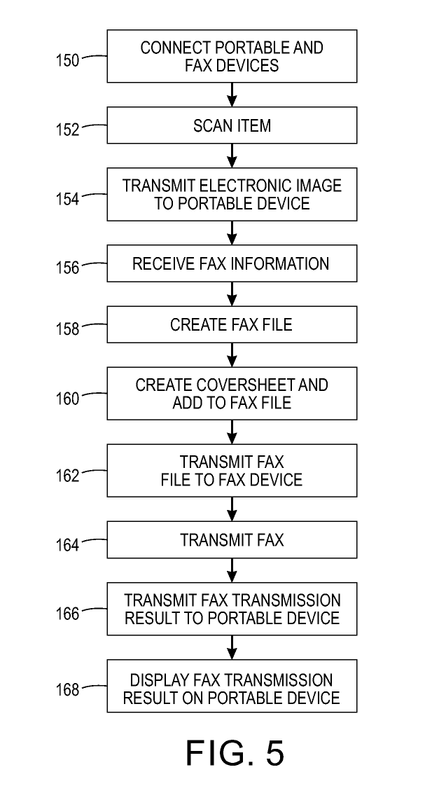

FIG. 5 is flowchart illustrating exemplary methods herein. In item 150, these methods operatively (meaning directly or indirectly, such as using a wired connection or a wireless connection) connect a portable computing device to another device that is separate from the portable computing device and that has, among other components, an optical scanner and a facsimile modem. Such a wireless connection can occur automatically as soon as the portable computerized device 200 and the separate device 204 are within a threshold distance from one another.

Once the two are connected, the user places an item on/in the scanner and these methods operate (start, open, call, etc.) an application on the portable computing device. The application can be automatically or manually started, opened, or called by user input to the user interface of the portable computing device 200, or the application can automatically start upon being connected to the separate device 204 (or the application can constantly run in the background of the portable computing device 200). The application (potentially automatically) causes/controls the optical scanner to scan an item to create an electronic image of the item, as shown in item 152.

Further, in item 154, with these methods, the application on the portable computing device causes/controls the separate device to transmit the electronic image to the portable computing device (potentially automatically). Also, in item 156, the application receives facsimile information, such as the recipient's facsimile telephone number, name, company, etc., into a graphic user interface of the portable computing device.

Then, in item 158, with these methods, the application operating on the portable computing device automatically creates a facsimile file by converting and combining the electronic image and the facsimile information (e.g., by including the facsimile information in a header of the facsimile file). As noted above, the conversion can be performed using a library resident on the portable computing device. As shown in item 160, these methods can also automatically create a facsimile coversheet by placing portions of the facsimile information into a facsimile coversheet template, using the portable computing device, and then automatically add the facsimile coversheet to the facsimile file. Then, in item 162 these methods automatically transmit the facsimile file from the portable computing device to the separate device, using the application.

In addition, with these methods, the application (potentially automatically) causes the separate device to send the converted electronic image (potentially with the coversheet) as a facsimile using the facsimile information contained within the facsimile file in item 164. After the facsimile transmission is successful (or fails) the portable computing device receives the result of the attempt to send the facsimile from the separate device (item 166) and this result is automatically displayed on the graphic user interface of the portable computing device in item 168.

The hardware described herein plays a significant part in permitting the foregoing method to be performed, rather than function solely as a mechanism for permitting a solution to be achieved more quickly, (i.e., through the utilization of a computer for performing calculations). For example: the graphic user interface displaying options to, and receiving input from, the user; the processor converting electronic signals in the form of a bitmap into a different electronic format (e.g., PDL); the processor controlling some operations of the separate facsimile-capable device; the facsimile modem electronically sending bits of data over a telephone network; etc., are hardware components that play a significant part in permitting the method shown in FIG. 5 to be performed.

FIG. 6 illustrates a computerized device 200, which can be used with systems and methods herein and can comprise, for example, a smart phone, tablet, portable digital assistant (PDA), or other portable computerized component, etc. Such devices are special-purpose devices distinguished from general-purpose computers because such devices include specialized hardware (filters, buffers, application specific integrated circuits (ASICs), ports, graphic user interfaces, antenna, converters, communication processors, GPS equipment, etc.) that are specialized for phone communications, for use with cellular networks, for obtaining images with camera components, for location determination using GPS equipment, have specialized batteries, have specialized protective cases for use in harsh environments, etc.

The computerized device 200 includes a special-purpose controller/tangible processor 216 and a communications port (input/output) 214 operatively connected to the tangible processor 216. Also, the computerized device 200 can include at least one accessory functional component, such as a graphical user interface (GUI) assembly 212. The user may receive messages, instructions, and menu options from, and enter instructions through the keyboard/keypad, touch screen, voice recognition, etc., of the graphical user interface or control panel 212.

The input/output device 214 is used for communications to and from the computerized device 200 and comprises a wired device or wireless device (of any form, whether currently known or developed in the future). The tangible processor 216 controls the various actions of the computerized device. A non-transitory, tangible, computer storage medium device 210 (which can be optical, magnetic, capacitor based, etc., and is different from a transitory signal) is readable by the tangible processor 216 and stores instructions that the tangible processor 216 executes to allow the computerized device to perform its various functions, such as those described herein. Thus, as shown in FIG. 6, a body housing has one or more functional components that operate on power supplied from an alternating current (AC) source 220 by the power supply 218. The power supply 218 can comprise a common power conversion unit, power storage element (e.g., a battery, etc), etc.

FIG. 7 illustrates a computerized device that is, in this example, a printing device 204 with a facsimile modem, which can be used with systems and methods herein and can comprise, for example, a printer, copier, multi-function machine, multi-function device (MFD), etc. The printing device 204 includes many components, some of which are illustrated, such as at least one marking device (printing engine(s)) 240 operatively connected to a specialized image processor 224 (that is different than a general purpose computer because it is specialized with filters, buffers, ASICs, ports, converters, etc., for processing image data, controlling motors, controlling heating elements, etc.), a media path 236 positioned to supply continuous media or sheets of media from a sheet supply 230 to the marking device(s) 240, etc. After receiving various markings from the printing engine(s) 240, the sheets of media can optionally pass to a finisher 234 which can fold, staple, sort, etc., the various printed sheets. Also, the printing device 204 can include at least one accessory functional component (such as a scanner/document handler 232 (automatic document feeder (ADF)), etc.), facsimile modem 208, etc., that also operate on the power supplied from the external power source 220 (through the power supply 218).

As would be understood by those ordinarily skilled in the art, the printing device 204 shown in FIG. 7 is only one example and the systems and methods herein are equally applicable to other types of printing devices that may include fewer components or more components. For example, while a limited number of printing engines and paper paths are illustrated in FIG. 7, those ordinarily skilled in the art would understand that many more paper paths and additional printing engines could be included within any printing device used with systems and methods herein.

While some exemplary structures are illustrated in the attached drawings, those ordinarily skilled in the art would understand that the drawings are simplified schematic illustrations and that the claims presented below encompass many more features that are not illustrated (or potentially many less) but that are commonly utilized with such devices and systems. Therefore, Applicants do not intend for the claims presented below to be limited by the attached drawings, but instead the attached drawings are merely provided to illustrate a few ways in which the claimed features can be implemented.

Many computerized devices are discussed above. Computerized devices that include chip-based central processing units (CPU's), input/output devices (including graphic user interfaces (GUI), memories, comparators, tangible processors, etc.) are well-known and readily available devices produced by manufacturers such as Dell Computers, Round Rock Tex., USA, and Apple Computer Co., Cupertino Calif., USA. Such computerized devices commonly include input/output devices, power supplies, tangible processors, electronic storage memories, wiring, etc., the details of which are omitted herefrom to allow the reader to focus on the salient aspects of the systems and methods described herein. Similarly, printers, copiers, scanners and other similar peripheral equipment are available from Xerox Corporation, Norwalk, Conn., USA, and the details of such devices are not discussed herein for purposes of brevity and reader focus.

The terms printer or printing device as used herein encompasses any apparatus, such as a digital copier, bookmaking machine, facsimile machine, multi-function machine, etc., which performs a print outputting function for any purpose. The details of printers, printing engines, etc., are well-known and are not described in detail herein to keep this disclosure focused on the salient features presented. The systems and methods herein can encompass systems and methods that print in color, monochrome, or handle color or monochrome image data. All foregoing systems and methods are specifically applicable to electrostatographic and/or xerographic machines and/or processes.

A scanner is one image capture device that optically scans images, print media, and the like, and converts the scanned image into a digitized format. Common scanning devices include variations of the flatbed scanner, generally known in the arts, wherein specialized image receptors move beneath a platen and scan the media placed on the platen. Modern digital scanners typically incorporate a charge-coupled device (CCD) or a contact image sensor (CIS) as the image sensing receptor(s). The scanning device produces a signal of the scanned image data. Such a digital signal contains information about pixels such as color value, intensity, and their location within the scanned image.

In addition, terms such as “right”, “left”, “vertical”, “horizontal”, “top”, “bottom”, “upper”, “lower”, “under”, “below”, “underlying”, “over”, “overlying”, “parallel”, “perpendicular”, etc., used herein are understood to be relative locations as they are oriented and illustrated in the drawings (unless otherwise indicated). Terms such as “touching”, “on”, “in direct contact”, “abutting”, “directly adjacent to”, etc., mean that at least one element physically contacts another element (without other elements separating the described elements). Further, the terms automated or automatically mean that once a process is started (by a machine or a user), one or more machines perform the process without further input from any user.

It will be appreciated that the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims. Unless specifically defined in a specific claim itself, steps or components of the systems and methods herein cannot be implied or imported from any above example as limitations to any particular order, number, position, size, shape, angle, color, or material.

1. A method comprising:
operatively connecting a portable computing device to a separate device, said separate device having an optical scanner and a facsimile modem;
operating an application on said portable computing device to cause said optical scanner to scan an item to create an electronic image of said item;
causing said separate device to transmit said electronic image to said portable computing device, using said application;
receiving facsimile information comprising a telephone number into a graphic user interface of said portable computing device, using said application;
creating a facsimile file by combining said electronic image and said facsimile information and including said facsimile information in a header of said facsimile file using said application operating on said portable computing device, said facsimile file having a file format usable by said separate device;
transmitting said facsimile file from said portable computing device to said separate device, using said application;
causing said separate device to send said electronic image as a facsimile telephone transmission using said facsimile information contained within said facsimile file, using said application;
receiving, by said portable computing device from said separate device, a result of said separate device attempting to send said facsimile; and
displaying, on said graphic user interface of said portable computing device, said result of said separate device attempting to send said facsimile, using said application.

2. (canceled)

3. The method according to claim 1, further comprising creating a facsimile coversheet by placing portions of said facsimile information into a facsimile coversheet template, using said portable computing device.

4. The method according to claim 3, said creating said facsimile file further comprising including said facsimile coversheet within said facsimile file.

5. The method according to claim 1, said file format comprising any page description language (PDL) format, including postscript (PS), portable document format (PDF), printer control language (PCL), graphics interchange format (GIF), tag image file format (TIFF), portable bitmap (PBM), and portable network graphics (PNG).

6. (canceled)

7. The method according to claim 1, said operatively connecting said portable computing device to said separate device comprising a wired or wireless connection.

8. A method comprising:
operatively connecting a smart phone to a multi-function printing device, said multi-function printing device having an optical scanner and a facsimile modem;
operating an application on said smart phone to cause said optical scanner to scan an item to create an electronic image of said item;
causing said multi-function printing device to transmit said electronic image to said smart phone, using said application;
receiving facsimile information comprising a telephone number into a graphic user interface of said smart phone, using said application;
creating a facsimile file by combining said electronic image and said facsimile information and including said facsimile information in a header of said facsimile file using said application operating on said smart phone, said facsimile file having a file format usable by said multi-function printing device;
transmitting said facsimile file from said smart phone to said multi-function printing device, using said application;
causing said multi-function printing device to send said electronic image as a facsimile telephone transmission using said facsimile information contained within said facsimile file, using said application;
receiving, by said smart phone from said multi-function printing device, a result of said multi-function printing device attempting to send said facsimile; and
displaying, on said graphic user interface of said smart phone, said result of said multi-function printing device attempting to send said facsimile, using said application.

9. (canceled)

10. The method according to claim 8, further comprising creating a facsimile coversheet by placing portions of said facsimile information into a facsimile coversheet template, using said smart phone.

11. The method according to claim 10, said creating said facsimile file further comprising including said facsimile coversheet within said facsimile file.

12. The method according to claim 8, said file format comprising any page description language (PDL) format, including postscript (PS), portable document format (PDF), printer control language (PCL), graphics interchange format (GIF), tag image file format (TIFF), portable bitmap (PBM), and portable network graphics (PNG).

13. (canceled)

14. The method according to claim 8, said operatively connecting said smart phone to said multi-function printing device comprising a wired or wireless connection.

15. A portable computing device comprising:
a processor operating an application;
a graphic user interface operatively connected to said processor; and
an input/output connection comprising one of a wired connection and a wireless connection,
said input/output connection operatively connecting to a separate device, said separate device having an optical scanner and a facsimile modem,
said application causing said optical scanner to scan an item to create an electronic image of said item,
said application causing said separate device to transmit said electronic image to said portable computing device,
said graphic user interface receiving facsimile information comprising a telephone number,
said application creating a facsimile file by combining said electronic image and said facsimile information and including said facsimile information in a header of said facsimile file,
said facsimile file having a file format usable by said separate device,
said input/output connection transmitting said facsimile file to said separate device,
said application causing said separate device to send said electronic image as a facsimile telephone transmission using said facsimile information contained within said facsimile file,
said input/output connection receiving, from said separate device, a result of said separate device attempting to send said facsimile, and
said graphic user interface displaying said result of said separate device attempting to send said facsimile.

16. (canceled)

17. The portable computing device according to claim 15, further comprising said application creating a facsimile coversheet by placing portions of said facsimile information into a facsimile coversheet template, using said portable computing device.

18. The portable computing device according to claim 17, said application creating said facsimile file further comprising including said facsimile coversheet within said facsimile file.

19. The portable computing device according to claim 15, said file format comprising any page description language (PDL) format, including postscript (PS), portable document format (PDF), printer control language (PCL), graphics interchange format (GIF), tag image file format (TIFF), portable bitmap (PBM), and portable network graphics (PNG).

20. (canceled)
